(19) United States
(12) Patent Application Publication
(10) Pub. No.: US 2017/0234349 A1
(43) Pub. Date: Aug. 17, 2017

(54) FASTENER ARRANGEMENTS AND ARTICLES COMPRISING SAME

(71) Applicant: RS Sourcing Limited, Hong Kong (HK)

(72) Inventor: Chen Ho Cheng, Hong Kong (HK)

(73) Assignee: RS Sourcing Limited, Hong Kong (HK)

(21) Appl. No.: 15/518,485

(22) PCT Filed: Oct. 20, 2015
(86) PCT No.: PCT/IB2015/058066

§ 371 Date: Apr. 12, 2017

(30) Foreign Application Priority Data
Oct. 20, 2014 (HK) 14110456.0

(51) Int. Cl. F16B 21/08

(52) U.S. Cl. CPC F16B 21/086

(57) ABSTRACT

An article kit (100) comprising a first article part (120) and a second article part (140) is disclosed. The first article part (120) comprises a first housing portion (122) and a first fastener part (162,182) and the second article part (140) comprises a second housing portion (142) and a second fastener part (164,184). The first and second article parts (120,140) are relatively movable into a snap-fitted or latched engagement configuration by cooperative latching between the first and second fastener parts (162,182,164,184). The first fastener part (162,182) comprises a latching arrangement (1622a,1622b,1822a,1822b) and the second fastener part (164,184) comprises a latch anchoring arrangement (1644,1844) and a locking arrangement (1642,1842).

### FIELD

The present disclosure relates to fastener arrangements and articles comprising fastening arrangements.

### BACKGROUND

Many articles comprise parts which are fastened together to form an assembly or sub-assembly. Typical fastening methods include gluing, welding, soldering or by mechanical fasteners such as screws, nails and rivets.

### DISCLOSURE

An article kit comprising a first article part and a second article part is disclosed. The first article part comprises a first housing portion and a first fastener part and the second article part comprises a second housing portion and a second fastener part. The first and second article parts are relatively movable into a snap-fitted or latched engagement configuration by cooperative latching between the first and second fastener parts. The first fastener part comprises a latching arrangement and the second fastener part comprises a latch anchoring arrangement and a locking arrangement. When the first fastener part and the second fastener part are in the snap-fitted or the engaged configuration or in the snap-fitted or the engaged position, the latching arrangement is latched or anchored in an anchored position on the latch anchoring arrangement, and the locking arrangement (or the latch locking arrangement) is in a locking configuration or a locking position to hold the latching arrangement on the latch anchoring arrangement. When in this locking configuration, the locking arrangement is to act against releasing movement or potential releasing movement of the latching arrangement in a direction to unlatch or release from latched engagement after the first and second article parts have been moved into latched engagement when the latching arrangement is latched or anchored in an anchored position on the latch anchoring arrangement.

A fastener comprising the first and second fastener parts of the present disclosure is advantageous. For example, as the first and second fasteners can be fastened by snap-fitting or latching the first and the second article parts together, a plurality of fasteners distributed at different locations on the article parts can be snap fastened in a single step and without using fastening tools or without the need to sequentially fasten the plurality of corresponding fastening parts at different locations, different angular orientation or different levels, thereby saving efforts, labour costs and assembly time.

The fastener comprising the locking arrangement is further advantageous as it confers a more secured fastening with tamper-proof measures.

The locking arrangement may be formed or configured to move into the locking configuration at the same time when the first fastener part and the second fastener part are moved into the snap-fitted or latch engaged configuration or position. This facilitates a single step latching and locking. For example, the locking arrangement may be integrally moulded on the second fastener part to facilitate one step latching and locking.

In some embodiments, the locking arrangement may also be configured to drive the latching arrangement into the snap-fitted or latch-engaged configuration or position when the first and the second fastener parts are being moved relatively towards each other and towards the snap-fitted or latched engagement configuration. In some embodiments, the locking member may comprise a drive member which drives the latching arrangement into snap-fit or latch-engagement and then secures the latching arrangement in a locked configuration.

The first and second fastener parts may be shaped, dimensioned and devised for interference fit such that the latching arrangement has to overcome interference deformation in order to move towards or into the anchored position. The interference fit plus the locking arrangement facilitates a more robust non-return or non-reversible fastening.

The latching arrangement may comprise a lever portion and a catch portion.

In some embodiments, the lever portion has a fixed end on a base portion of the first housing portion, a free end distal from the base portion and an axially extending intermediate portion interconnecting the fixed end and the free end, and the catch portion projects radially or transversely from the lever portion at an axial distance distal from the base portion.

The lever portion has a cantilever type structure having a free end which is moveable or flexible between an interference-free anchored position and an interfered position while moving into the anchored position.

The latch anchoring arrangement may comprise an axially extending anchoring wall portion on the second fastener part and an undercut portion which is formed on anchoring wall portion; and wherein the latching arrangement is to experience interference deformation on encountering the anchoring wall portion when moving towards or into the anchored position.

In some embodiments, the latching arrangement comprises a lever portion and a catch portion wherein the lever portion has a fixed end on a base portion of the first housing portion, a free end distal from the base portion and an axially extending intermediate portion interconnecting the fixed end and the free end, and the catch portion projects radially or transversely from the lever portion at an axial distance distal from the base portion. The latch anchoring arrangement may comprise an axially extending anchoring wall portion on the second fastener part and an undercut portion which is formed on the anchoring wall portion. During engagement operations, the latching arrangement is to experience interference deformation on encountering the anchoring wall portion when moving towards or into the anchored position.

The lever portion may comprise a plurality of cantilevers and the undercut portion may comprise a plurality of undercuts corresponding to the same plurality of cantilevers, the undercut extending transversely or radially, and the undercuts are correspondingly distributed on the anchoring wall portion to receive the corresponding plurality of catches on said cantilevers.

In some embodiments, the catch portion projects radially outwardly, and the latching arrangement is received inside a compartment which is defined by the locking arrangement and the latch anchoring arrangement and urged outwardly by the locking arrangement towards the anchored position when in latched engagement. Where the catch portion projects radially outwardly, the undercut portion is formed on the inside of the anchoring wall portion.

In some embodiments, the catch portion projects radially inwardly, and the latching arrangement is received inside a compartment which is defined by the locking arrangement and the latch anchoring arrangement and urged inwardly by the locking arrangement towards the anchored position when in latched engagement. Where the catch portion projects radially inwardly, the undercut portion is formed on the outside of the anchoring wall portion.

The latching arrangement may define a compartment having radial or transversal dimensions, and the radial or transversal dimensions of the compartment are changed when the first and second article parts are in the course of moving relatively in an axial direction into the latched engagement. The locking arrangement may comprise a wedging protrusion which is to act against reversing changes in the radial or transversal dimensions of the compartment after the first and second article parts are in the latched engagement. The wedging protrusion may be an axially extending member having a frusto-conical or tapered driving head. The frusto-conical or tapered driving head may operate to drive the latching member to overcome interference resistance while moving towards the snap-fitted or the engaged configuration or in the snap-fitted or the engaged position.

In some embodiments, the latching arrangement comprises a plurality of axially extending lever members, each lever member having a fixed end on the first housing portion, a free end distal to or away from the first housing portion, and a radially or transversely extending catch member proximal the free end, and the lever members are distributed to define the radial or transversal dimensions of the compartment.

The lever members may be distributed in a geometric configuration selected among one of circular, polygonal, on two sides, for example, on two-parallel sided configurations, or in other distribution.

The catch member on each of the lever members may project outwardly or away from the compartment, the wedging protrusion is received inside the receptacle and the plurality of lever members is intermediate the latch anchoring arrangement and the compartment when in latched engagement.

The catch member on each of the lever members may project inwardly into the compartment, the latch anchoring arrangement is inside the compartment and the plurality of lever members is intermediate the compartment and the wedging protrusion when in the latched engagement.

### FIGURES

The present disclosure will be explained by way of example and with reference to the accompanying Figures, in which:—

FIG. 1 shows a perspective external view of an example article according to the present disclosure,

FIG. 1A is a longitudinal cross-sectional view of the article of FIG. 1 taken along line A-A′,

FIG. 2 is a first perspective view showing parts of the article of FIG. 1 before assembly,

FIG. 2A is an enlarged view of an example first fastener part of FIG. 2,

FIG. 2B is an enlarged view of another example first fastener part of FIG. 2,

FIG. 3 is a second perspective view showing parts of the article of FIG. 1 before assembly,

FIG. 3A is an enlarged view of an example second fastener part of FIG. 3,

FIG. 3B is an enlarged view of another example second fastener part of FIG. 3,

FIG. 4 is a perspective external view of an example article according to the disclosure,

FIG. 4A is a longitudinal cross-sectional view of the article of FIG. 4 taken along line B-B′,

FIG. 4B is a longitudinal cross-sectional view of the article of FIG. 4 taken along line C-C′,

FIG. 5 is a first perspective view showing a first part of the article of FIG. 4 before assembly,

FIG. 5A is an enlarged view of an example first fastener part shown in FIG. 5,

FIG. 5B is an enlarged view of another example first fastener part shown in FIG. 5,

FIG. 6 is a second perspective view showing a second part of the article of FIG. 4 before assembly,

FIG. 6A is an enlarged view showing an example second fastener part of FIG. 6,

FIG. 6B is an enlarged view showing another example second fastener part of FIG. 6,

FIG. 7 shows a perspective view of an example toy vehicle incorporating fastener arrangements according to the present disclosure,

FIGS. 7A and 7B respectively show an upper housing portion and a low housing portion of the toy vehicle of FIG. 7,

FIG. 8 depicts a fastener part according to an embodiment of the present disclosure,

FIG. 8A depicts a counterpart fastener part of that of FIG. 8, and

FIG. 8B is an axial cross-sectional view of a fastener arrangement comprising the counterpart fastener parts of FIGS. 8 and 8A in latched engagement.

### DESCRIPTION

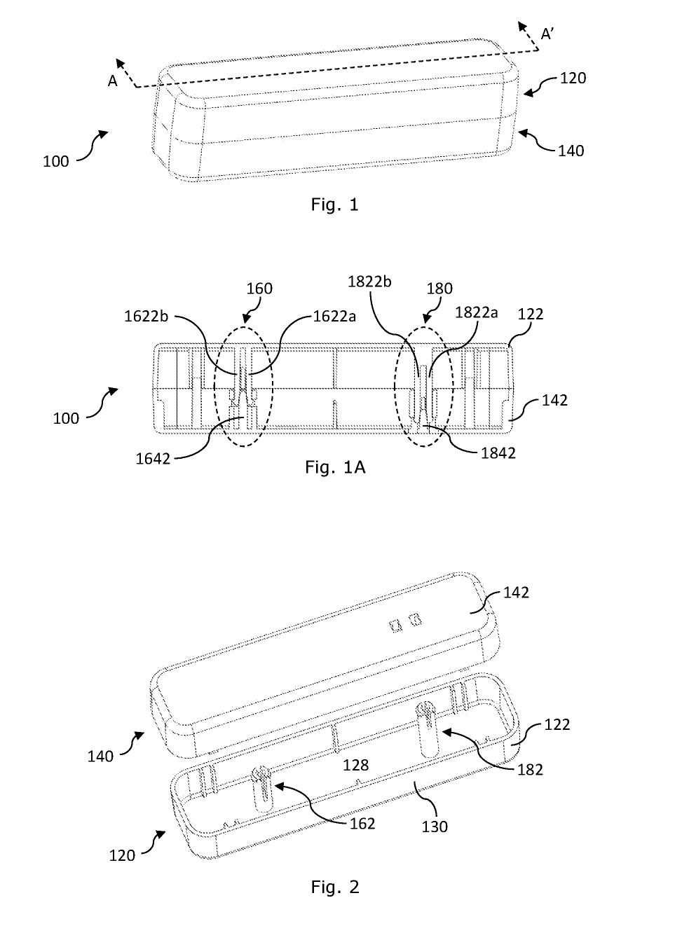

An example article 100 depicted in FIG. 1 comprises a first article part 120 and a second article part 140 which are fastened together by a plurality of fastening arrangements. The first article part 120 and the second article part 140 are connected by cooperative engagement between a first fastener 160 and a second fastener 180, as depicted in the longitudinal cross-sectional view of FIG. 1A. Each of the first 120 and second 140 article parts comprises a housing portion and the housing portions of the first 120 and second 140 article parts cooperate to define an internal compartment. Each one of the first 160 and second 180 fasteners extends transversely across the internal compartment and connecting the first 120 and second 140 article parts.

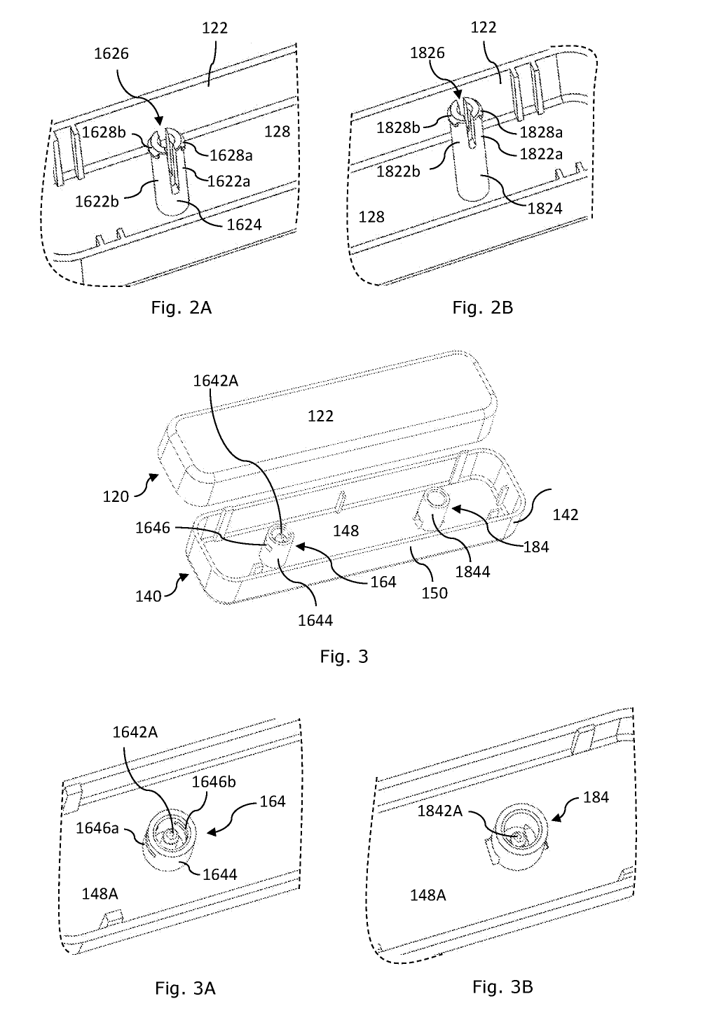

Referring to FIGS. 2, 2A and 2B, the first article part 120 comprises a first housing portion 122 and a plurality of fastening parts 162 and 182 of a first type formed thereon. The first housing portion 122 comprises a base portion 128 which defines a floor portion and a first peripheral wall portion 130 which surrounds the floor portion and which extends upwardly or transversely from an outer edge of the floor portion. The base portion 128 and the first peripheral wall portion 130 cooperate to define the shape and boundary outline of a first internal compartment portion. The fastening parts 162, 182 are distributed on the floor portion and extend upwardly and away from the floor portion towards an upper aperture defined by the peripheral wall portion 130. Each of the fastening parts 162, 182 projects transversely upwards from the floor portion in this example, but may project at an inclination or angular orientation towards the upper aperture without loss of generality. The fastening parts 162, 182 are distributed along a longitudinal axis of symmetry of the floor portion in this example, but may be distributed in other manners without loss of generality. The distributed fastening parts 162, 182 when connected or engaged with their counterpart fastener parts provide distributed connection and support between the first 120 and second 140 article parts. Each of the fastening parts 162, 182 projects above and beyond the upper free edge of the peripheral wall portion 130 in this example, but the fastener part 162, 182 may stop below the upper free edge of the peripheral wall portion 130 where the corresponding or counterpart fastener part projects above and beyond the upper free edge of the peripheral wall portion 130.

Referring to FIGS. 3, 3A and 3B, the second article part 140 comprises a second housing portion 142 and a plurality of fastening parts 164 and 184 of a second type formed thereon. The fastener part 164 is a corresponding counterpart of and complementary to the fastening parts 162 and the fastener part 184 is a corresponding counterpart of and complementary to the fastening parts 182. The second housing portion 142 comprises a base portion 148 which defines a floor portion 148A and a second peripheral wall portion 150 which surrounds the floor portion and which extends upwardly or transversely from an outer edge of the floor portion. The base portion 148 and the second peripheral wall portion 150 cooperate to define the shape and boundary outline of a second internal compartment portion. The fastening parts 164, 184 are distributed on the floor portion and extend upwardly and away from the floor portion towards an upper aperture defined by the second peripheral wall portion 150. Each of the fastening parts 164, 184 projects transversely upwards from the floor portion in this example, but may project at an inclination or angular orientation towards the upper aperture to correspond with the inclination or angular orientation of the counterpart fastening part 162, 182 without loss of generality.

The fastening parts 164, 184 are distributed along a longitudinal axis of symmetry of the floor portion in this example, but may be distributed in other manners to correspond with the manner of distribution of the counterpart fastening part 162, 182 without loss of generality. The distributed fastening parts 164, 184 when connected or engaged with their counterpart fastener parts 162, 182 provide distributed connection and support between the first 120 and second 140 article parts. Each of the fastening parts 164, 184 has a free end which is below the upper free edge of the peripheral wall portion 150 in this example, but the fastener part 164, 184 may project above and beyond the upper free edge of the peripheral wall portion 150 where the corresponding or counterpart fastener part ends below the upper free edge of the peripheral wall portion 150.

When the first 120 and second 140 article parts are assembled by cooperative latched engagement of the fastening arrangements comprising the counterpart fastener parts 162, 164; 182, 184, the first article part 120 and the second article part 140 are in a stacking relationship and in a stack assembled configuration. When in this stacked assembled configuration, the first peripheral wall portion 130 and the second peripheral wall portion 150 are in a stacking relationship to define an overall peripheral wall portion, and the first internal compartment and the second internal compartment are integrated to form an overall internal compartment defined by the surrounding overall peripheral wall portion.

In this example, the first peripheral wall portion 130 and the second peripheral wall portion 150 have the same shape and outline and the counterpart fastener parts 162, 164; 182, 184 are distributed so that when the first 120 and second 140 article parts are assembled by latched connection or engagement, the first peripheral wall portion 130 and the second peripheral wall portion 150 are flush with each other. When the first article part 120 and the second article part 140 are in engagement, the free upper edge of the first peripheral wall portion 130 and the free upper edge of the second peripheral wall portion 150 are in abutment to define a smooth or continuous junction between the first 130 and the second 150 peripheral wall portion to define the overall peripheral wall surrounding the overall internal compartment which is formed by joining the first and second internal compartment portions.

When the first peripheral wall portion 130 and the second peripheral wall portion 150 are stacked, the overall peripheral wall portion has a height in the transverse direction which is due to the sum of heights in the transverse direction of the first peripheral wall portion 130 and the second peripheral wall portion 150, and the volume of the overall internal compartment is due to the sum of the volumes of the first internal compartment and the second internal compartment.

While the overall peripheral wall portion has a height which is larger than the height of the individual peripheral wall portion in this example, the height of the overall peripheral wall portion may be due only to one of the constituting peripheral wall portions in some embodiments without loss of generality. Likewise, the volume of the overall internal compartment may be due to the volume of one of the constituting internal compartments or less without loss of generality.

While fastener parts of the first type are formed on the first article part and fastener parts of the second type are shown on the second article part as a convenient example, it should be appreciated that fastener parts of the first type, fastener parts of the second type, or a mixture thereof can be formed on the first article part or the second article part without loss of generality.

A fastener part of the first type 162, 182 comprises an axially extending lever portion and a catch portion which projects radially from the lever portion, as depicted in FIGS. 1A, 2 and 2A. The radially extending catch portion is formed at or near an axial free end of the lever portion. The lever portion and a catch portion cooperate to define an example latch arrangement.

Referring to FIGS. 2 and 2A, the fastener part 162 comprises a first axial portion 1622a and a second axial portion 1622b. Each of the first and second axial portions 1622a, 1622b is axially extending and projects upwardly from a common base portion 1624 on the first housing portion. The first axial portion 1622a and the second axial portion 1622b are on opposite sides of an axial axis, are oppositely facing and are separated by an axial channel 1626. A first radial projection 1628a is formed on the outward facing surface of the first axial portion 1622a and a second radial projection 1628b is formed on the outward facing surface of the second axial portion 1622b. The first and second radial projections 1628a and 1628b are diametrically opposite and are at substantially the same axial level to form a latching device. Each one of the first and second radial projections 1628a and 1628b forms catch of a latch. The first and second radial projections 1628a and 1628b are located near the free or top end of the axial portions 1622a and 1622b and are distal to the base portion 1624. The first and second axial portions 1622a, 1622b and the common base portion 1624 are integrally made of hard and rigid materials such as hard plastics. The first and second axial portions 1622a, 1622b are resiliently movable about the base portion 1624 as a hinge joint to change the radial extent of the latching device as defined by radial extent of the radial projections 1628a and 1628b. The base portion 1624 is a solid to provide a robust base for the axial portions 1622a and 1622b to cantilever. The axial channel 1626 includes a first portion which defines an elongate split between the first and second axial portions 1622a and 1622b and a second portion which defines an axial receptacle or locking receptacle for receiving a locking or retention device on a counterpart fastener part. The elongate split between the first and second axial portions 1622a and 1622b facilitate relative resilient pivotal movement of the axial portions 1622a and 1622b about the base portion 1624. When the split between the axial portions 1622a and 1622b is at maximum, the first and second axial portions 1622a and 1622b and the first and second radial projections 1628a and 1628b are at an expanded configuration corresponding to a latching configuration. Each of the first and second axial portions 1622a, 1622b defines a lever member of a latch device and each of the corresponding radial projections 1628a and 1628b defines a catch member of a latch device.

The fastener part 182 is substantially identical to the fastener part 162 except that it has a larger height and the bottom of the split is at an elevation level higher than that of the fastener part 162. As the parts are substantially identical, the description on the fastener part 162 herein is applied, mutatis mutandis, to the fastener part 182 with corresponding numerals on the parts added by 200.

A fastener part of the second type 164, 184 comprises a latch anchoring arrangement and a latch locking arrangement. The latch anchoring arrangement comprises anchoring means for the latch arrangement to anchor or latch on and the latch locking arrangement is to retain the latch arrangement in an anchored or latched configuration against potential releasing movement of the latch arrangement.

Referring to FIGS. 3 and 3A, the fastener part 164 comprises an anchoring portion on which anchoring means is disposed and a latch locking device which is surrounded by the anchoring portion. The latch locking device comprises an upstanding protrusion member 1642 (or tongue member) which extends upwardly from the floor portion 148A of the base portion 148. The anchoring portion comprises a peripheral wall 1644 on which an undercut portion is formed. The undercut portion comprises a plurality of latching undercuts and the latching undercuts are distributed on the side of the peripheral wall 1644 which is oppositely facing the protrusion member 1642 and at locations to latch the catch portion of a counterpart fastener part. The peripheral wall 1644 extends upwardly from the floor portion of the base portion 148 and curls about a centre axis to surround the protrusion member 1642, the centre axis being transverse to the longitudinal axis A-A′. The peripheral wall 1644 has the shape of a circular collar or a chimney and a latch receptacle is defined by a space between the protrusion member 1642 and its surrounding peripheral wall 1644. The latch receptacle is shaped and dimensioned to permit transit passage of the catch portion of a counterpart fastener part of the first type 162, 182 into the latched position when in latching engagement with the undercut portion. After the catch portion of a counterpart fastener part has moved into the latched position, the lever portion of the counterpart fastener part will be received inside the latch receptacle and is compressively urged by the protrusion member 1642 to press against the peripheral wall 1644. As a result of the compressive pressing by the protrusion member 1642, the latching member is locked in the latched position.

In this example, undercuts 1646a and 1646b are formed at diametrically opposite sides of the centre axis and at the same elevation level above the floor portion 148A, which is also the centre axis of the protrusion member 1642. The undercuts 1646a and 1646b are formed as through latching apertures extending transversely to the centre axis, but it should be appreciated that through apertures are not essential.

The protrusion member 1642 comprises an axially extending main body and free end 1642A. The free end is at above the axial elevation of the undercuts and the main body is shaped and dimensioned to be in urging abutment with the lever portion of a counterpart fastener part of the first type 162, 182 when in the latched position. To facilitate smooth and expedient movement into the latched position, the protrusion member 1642 has a rounded free end which is tapered to narrow as it moves away from the main body and from the base portion. The transversal shape and dimensions of the main body of the protrusion member 1642 is such that it is sufficient to apply a compressively urging force to press the lever portion against the peripheral wall while at the same time permits interference deformed transition of the catch portion into the latched position. In general, the un-tapered main body should at least reach the axial elevation of the undercuts.

In some embodiments, the latch receptacle is shaped and dimensioned so that the catch portion of a counterpart fastener part of the first type 162, 182 is to experience interference deformation in order to transit into the latched position.

Where the latch receptacle is shaped and dimensioned such that the catch portion of the latch arrangement is to overcome interference resistance in order to transit into the latched position, the latch receptacle will have a lateral clearance smaller than the lateral extent of the catch portion of the latch arrangement. In this example, lateral extent of the catch portion is defined by the lateral extent of the first and second radial projections 1628a and 1628b.

The fastener part 184 is substantially identical to the fastener part 164 except that the latching apertures 1846a, 1846b are located at an axial level distal to the free end of the fastener part 184 and proximal the base portion 148. As the parts are substantially identical, the description herein on the fastener part 164 is applied, mutatis mutandis, to the fastener part 184 with corresponding numerals on the parts added by 200.

To assemble the first and second article parts 120 and 140, the first and second article parts 120 and 140 are aligned in an alignment direction so that the corresponding free edges of the peripheral wall portions 130, 150 and the corresponding counterpart fasteners parts are in axial alignment. When the first and second article parts 120 and 140 are aligned the first and second internal compartments and the corresponding counterpart fasteners parts are oppositely facing each other.

After the first and second article parts 120 and 140 are aligned in the engagement direction, further relative movement between the first and second article parts 120 and 140 in the axial direction will move the latch arrangement on a fastener part of the first type 162, 182 into the latch receptacle on a fastener part of the second type 164, 184. Initially, the catch portion of the fastener part 162 comprising the radial projections 1628a, 1628b will move into the initial portion of the latch receptacle which is defined between the tapered free end 1842A of the protrusion member and the anchoring wall. When the catch portion moves further into the narrower portion of the latch receptacle defined by the main body of the protrusion member and the anchoring wall, the smaller clearance means that the catch portion will have to overcome interference resistance and deform in a radial direction in order to transit to a latching position in latching engagement with the undercuts. Once the catch portion has progressed into the latching position, the catch portion will be free from interference resistance and can resume its original shape due to its inherent resilience. At the same time when the catch portion is progressing into the latching position, the protrusion member 1842, and more particularly the main body of the protrusion member 1842, is also progressing into the locking receptacle which is defined between the lever members 1622a and 1622b. When the catch portion has moved into the latching position, the protrusion member 1842 is also in a locking position inside the locking receptacle. When in this locking position, the main body of the protrusion member 1842 is compressively urging or pressing the lever members 1622a and 1622b against the anchoring wall, and acts against potential movement of the lever members 1622a and 1622b in a releasing direction. During movement of the protrusion member 1842 into the locking receptacle, the protrusion member 1842 operates as a wedging protrusion to wedge the lever members 1622a and 1662b into the locking position and against the anchoring wall.

As the protrusion member 1842 is to act against potential releasing movement of the lever members 1622a and 1622b when in the locking position, the counterpart fastener parts of this fastener arrangement forms a self-engaging and non-return fastening mechanism. Furthermore, once the protrusion of tongue member 1642 is inside the locking receptacle, a non-returnable or irreversible engagement between the counterpart fastener parts 162 and 164 is formed.

When the first and second article parts 120 and 140 are brought into connection engagement, the first housing portion 122 and the second housing portion 142 cooperate to form closed clam shell defining a closed internal compartment. In the example embodiments, the first and second article parts 120 and 140 are fastened when they are snapped together. The snap fastening provided by the fastening arrangements of the disclosure facilitates convenient yet robust connection of parts, especially parts to form an enclosure or closed compartment when assembled.

As the fastener parts are enclosed within the closed clam housing, the fastening arrangement is also tamper-proof and provides good anti-tampering measures.

In some embodiments, the engagement between one of the fastener parts 182 and 184 may be returnable when another fastening arrangement 160 is already non-returnable. For example, the axially projecting tongue member 1842 inside the fastener part 184 may be detachable after the fastener parts 182 and 184 are connected. The axially projecting tongue member may be attached to the base portion 148 of the second housing by a threaded end as an example. However, the formation of the non-returnable engagement between the fastener parts 162 and 164 has nevertheless resulted in non-accessibility to this engagement, even though this latched engagement is returnable or reversible.

In some embodiments, the fastener parts are integrally moulded as a single piece.

In some embodiments, the fastener parts are integrally moulded from a rigid resilient material such as hard plastics.

In some embodiments, the fastener parts are integrally moulded on the housing portions 128, 148.

In the above examples, the fastener parts project in a substantially orthogonal direction to the floor such that the first and second article parts are to move in a direction which is orthogonal or substantially orthogonal to the floor to enter into latched engagement.

In some embodiments, the fastener parts may project at an angle which is not orthogonal to the floor portion so that the direction of alignment and hence the direction of engagement is at an angle not orthogonal to the floor portion.

In general, and irrespective of the direction of engagement the fastener parts, the fastening arrangements disclosed herein facilitates automatic engagement between the first and second article parts when the first and second article parts are brought into a position of engagement and without the need of a tightening operation.

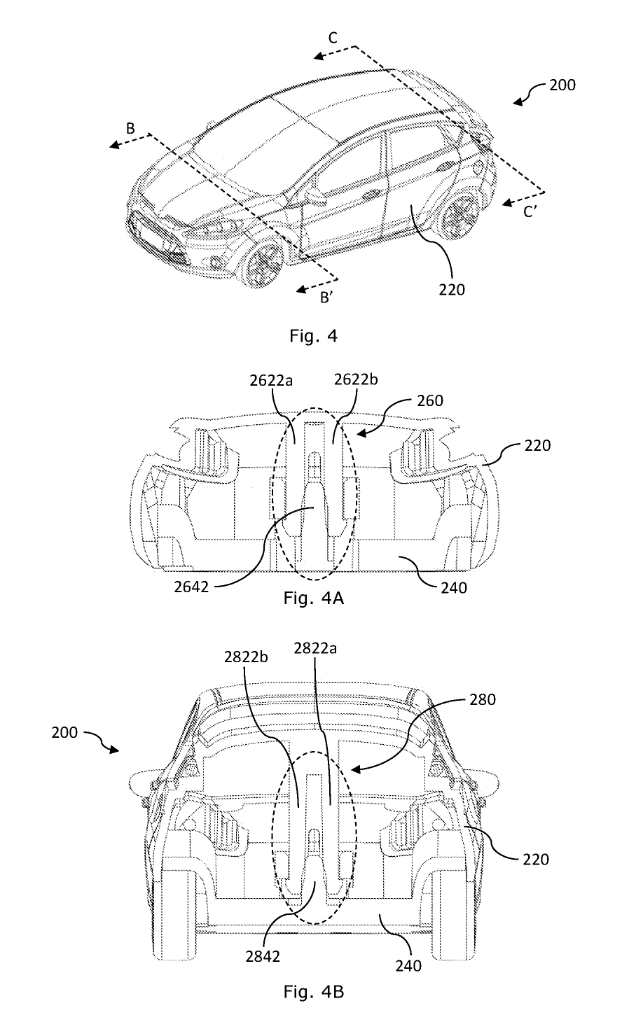

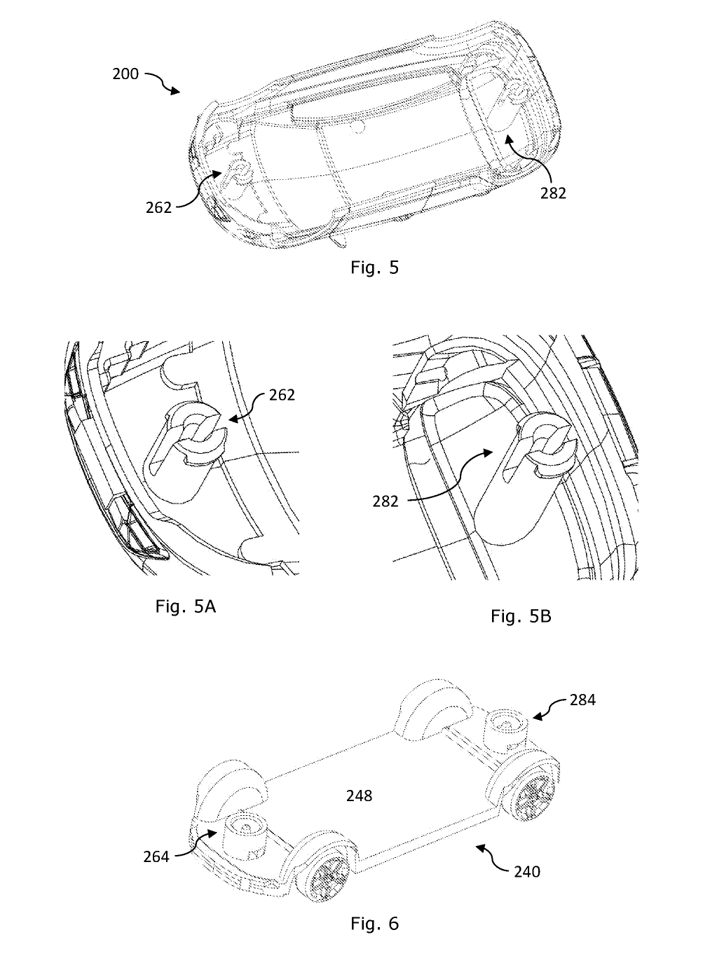

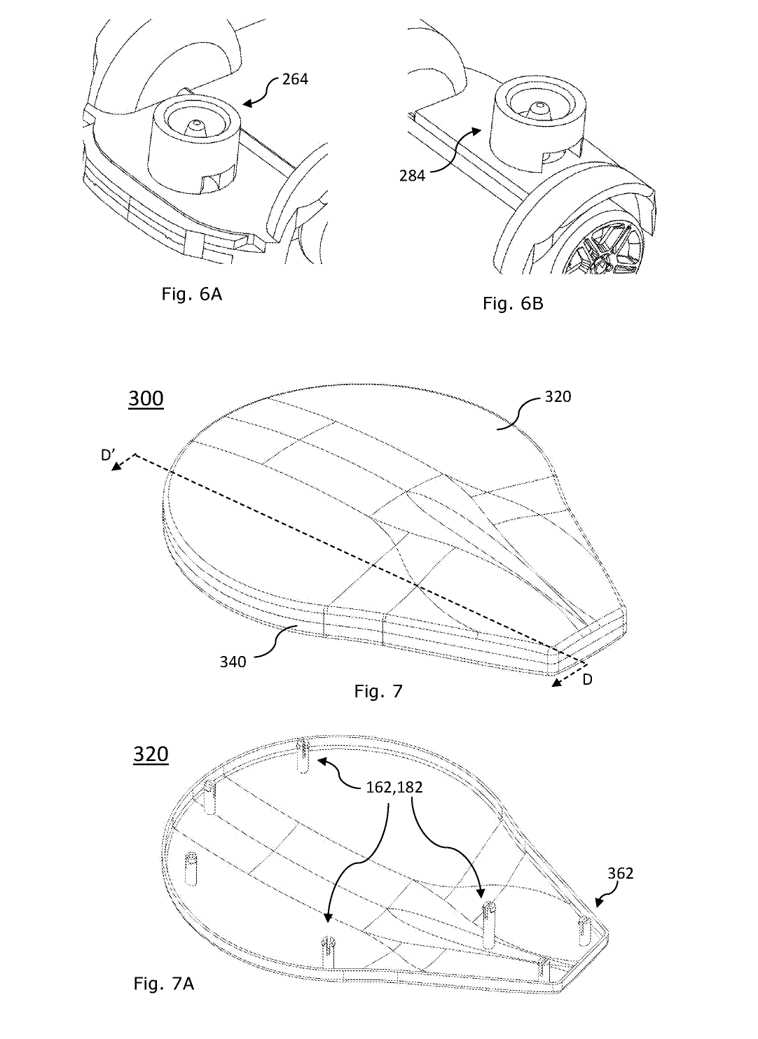

A toy vehicle 200 depicted in FIGS. 4 to 6B comprises an upper vehicle part 220 and a lower vehicle part 240, both moulded of hard plastics. As depicted in the cross-sectional view of FIG. 4A, the upper vehicle part 220 and the lower vehicle part 240 cooperate to define an internal vehicle compartment when connected by a first set of fastening arrangement 260 and a second set of fastening arrangement 280. The first fastening arrangement 260 is substantially the same as that of the first fastening arrangement 160. The second fastening arrangement 280 is substantially the same as that of the second fastening arrangement 180. The fastening arrangements 260, 280 are substantially identical to that of the fastening arrangements 160, 180 and descriptions thereon are incorporated herein by reference with relevant numbers added by 100 where appropriate. The utilization of the fastening arrangements disclosed herein facilitates robust and anti-tamper fastening without the need of extra fastening steps apart from bringing the two major parts together. Of course, additional fastening may be applied but the initial hassle-free fastening has provided substantial saving in the assembly process and is therefore advantageous.

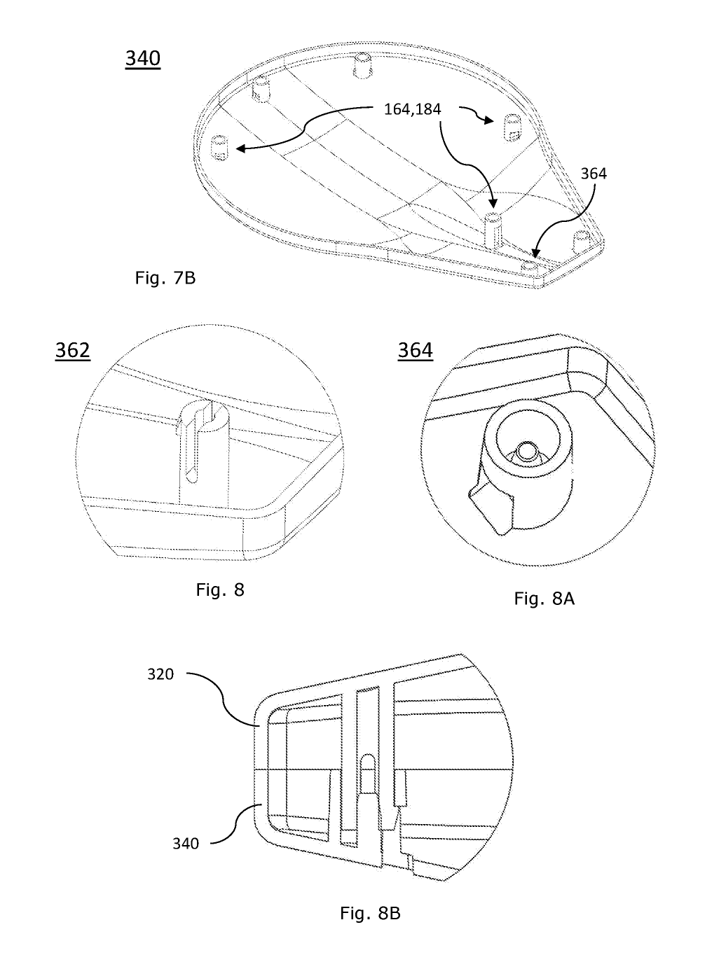

A toy vehicle depicted in FIG. 7 comprises an upper vehicle part 320 shown in FIG. 7A and a lower vehicle part 340 shown in FIG. 7B, both moulded of hard plastics and formed as clam shells. In this example, while the vehicle housing as defined by the shape and configuration of the upper vehicle part 320 and the lower vehicle part 340 is different to those of the other examples, the same the counterpart fastener parts 162, 164; 182, 184 are deployed.

A variation of a fastener arrangement is depicted in FIGS. 8, 8A and 8B. In this embodiment, a fastener part shown in FIG. 8 is substantially identical to the counterpart fastener part 162, 182 except that only one of the axial portions has a radial catch portion. A counterpart fastener part for cooperative latching with this fastener part is shown in FIG. 8A and has a single latching undercut to correspond with the single catch portion. FIG. 8B shows an axial cross-sectional view after this fastener arrangement is in a latched position.

While the catch portion projects radially outwards in the above embodiments, it should be appreciated that the catch portion may project radial inwards. Where the catch portion of a fastener part projects radial inwardly, the latching undercuts on a counterpart fastener part would be inside or in the interior of a compartment defined by the lever members of the latch arrangement and the locking protrusion member will act from outside of the latch arrangement. For example, the latching undercuts may be distributed on an exterior surface of an anchoring wall which is inside the compartment and the locking protrusion member may be in a tubular form to surround and embrace the axially extending lever members of the latch arrangement when in the latched configuration. The anchoring wall may have a circular or other profile.

While various example embodiments are shown and/or described herein, it should be appreciated that the example embodiments are not for limiting scope of disclosure or application. For example, while an example fastener part having two diametrically opposite lever members has been described, a fastener part may have one or more than two axially extending lever members without loss of generality.

1-19. (canceled)

20. An article kit comprising a first article part and a second article part, wherein the first article part comprises a first housing portion and a first fastener part and the second article part comprises a second housing portion and a second fastener part, the first and second article parts being relatively movable to enter into snap-fitted or latched engagement by cooperative latching between the first and second fastener parts, wherein the first fastener part comprises a latching arrangement and the second fastener part comprises a latch anchoring arrangement and a locking arrangement; wherein the locking arrangement is moved into a locking position or a locking configuration to act against releasing movement of the latching arrangement in a direction to unlatch or release from latched engagement after the first and second article parts have moved into latched engagement when the latching arrangement is latched or anchored in an anchored position or an anchored configuration on the latch anchoring arrangement.

21. The article kit according to claim 20, wherein the first and second fastener parts are shaped, dimensioned and devised for interference fit such that the latching arrangement has to overcome interference deformation in order to move towards or into the anchored position.

22. The article kit according to claim 21, wherein the latching arrangement comprises a lever portion and a catch portion, wherein the lever portion has a fixed end on a base portion of the first housing portion, a free end distal from the base portion and an axially extending intermediate portion interconnecting the fixed end and the free end, and the catch portion projects radially or transversely from the lever portion at an axial distance distal from the base portion; wherein the latch anchoring arrangement comprises an axially extending anchoring wall portion on the second fastener part and an undercut portion which is formed on anchoring wall portion; and wherein the latching arrangement is to experience interference deformation on encountering the anchoring wall portion when moving towards or into the anchored position.

23. The article kit according to claim 22, wherein the lever portion comprises a plurality of cantilevers and the undercut portion comprises a plurality of undercuts corresponding to the same plurality of cantilevers, the undercut extending transversely or radially, and the undercuts are correspondingly distributed on the anchoring wall portion to receive the corresponding plurality of catches on said cantilevers.

24. The article kit according to claim 23, wherein the catch portion projects radially outwardly, and the latching arrangement is received inside a compartment which is defined by the locking arrangement and the latch anchoring arrangement and urged outwardly by the locking arrangement towards the anchored position when in latched engagement.

25. The article kit according to claim 23, wherein the catch portion projects radially inwardly, and the latching arrangement is received inside a compartment which is defined by the locking arrangement and the latch anchoring arrangement and urged inwardly by the locking arrangement towards the anchored position when in latched engagement.

26. The article kit according to claim 20, wherein the first fastener part comprises a receptacle which is defined by the latching arrangement and radial or transversal dimensions of the receptacle are changed when the first and second article parts move relatively into the latched engagement in an axial direction, and wherein the locking arrangement is to act against reversing changes in the radial or transversal dimensions of the receptacle after the first and second article parts have moved into the latched engagement.

27. The article kit according to claim 26, wherein the locking arrangement comprises a wedging protrusion and the wedging protrusion is to act against reversing changes in the radial or transversal dimensions of the receptacle in a direction to unlatch or release the from latched engagement after the first and second article parts have moved into the latched engagement.

28. The article kit according to claim 27, wherein the wedging protrusion is received inside the receptacle or act from outside of the receptacle to act against the reversing changes when the first and second article parts are in latched engagement.

29. The article kit according to claim 20, wherein the latching arrangement defines a compartment having radial or transversal dimensions, and the radial or transversal dimensions of the compartment are changed when the first and second article parts are in the course of moving relatively in an axial direction into the latched engagement, and the locking arrangement comprises a wedging protrusion which is to act against reversing changes in the radial or transversal dimensions of the compartment after the first and second article parts are in the latched engagement.

30. The article kit according to claim 29, wherein the latching arrangement comprises a plurality of axially extending lever members, each lever member having a fixed end on the first housing portion, a free end distal to or away from the first housing portion, and a radially or transversely extending catch member proximal the free end, and wherein the lever members are distributed to define the radial or transversal dimensions of the compartment.

31. The article kit according to claim 30, wherein the lever members are distributed in a geometric configuration selected among one of circular, polygonal or on two-parallel sided configurations.

32. The article kit according to claim 31, wherein the catch member on each of the lever members projects outwardly or away from the compartment, the wedging protrusion is received inside the receptacle and the plurality of lever members is intermediate the latch anchoring arrangement and the compartment when in latched engagement.

33. The article kit according to claim 31, wherein the catch member on each of the lever members projects inwardly into the compartment, the latch anchoring arrangement is inside the compartment and the plurality of lever members is intermediate the compartment and the wedging protrusion when in the latched engagement.

34. The article kit according to claim 20, wherein the locking arrangement comprises a locking protrusion member, the locking protrusion member extending axially from a base portion of the second housing portion and has free end, the free has a tapered or frusto-conical shape which narrows in a direction away from the base portion.

35. The article kit according to claim 20, wherein the first housing portion comprises a first clam shell defining a first enclosure portion and the second housing portion comprises a second clam shell defining a second enclosure portion, wherein the first and second claim shells cooperate to define a complete or closed enclosure and the first fastener part and the second fastener part are enclosed within said complete or closed enclosure when the first fastener part and the second fastener part are in latched engagement.

36. The article kit according to claim 20, wherein the first and the second article parts are assembled to form an assembled article by relatively moving the first and second article parts towards each other in an axial direction and snapping the first and second article parts together so that the first and second fastener parts are entered into latched engagement.

37. The article assembled from the article kit according to claim 20.

38. The article according to claim 37, wherein the article is a toy or a model and the first and second article parts are moulded of resilient hard plastics.
